(19) United States
(12) Patent Application Publication
(10) Pub. No.: US 2002/0085730 A1
(43) Pub. Date: Jul. 4, 2002

(54) Briefcase or carrying case with integrated loudspeaker system

(76) Inventor: Bert E. Holland, Munich (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 09/997,495

(22) Filed: Nov. 19, 2001

(30) Foreign Application Priority Data
Nov. 17, 2000 (DE) 20019525.5

(51) Int. Cl. H04R 9/06

(52) U.S. Cl. 381/334

(57) ABSTRACT

Briefcase respectively carrying case for electronic devices or documents having a housing comprising a storage compartment arranged in the housing for storing at least one paper document, electronic device or object, at least one loudspeaker for reproduction of audio frequencies, which is mounted in either an outer or inner wall of the housing, wherein, when the document or electronic device is removed, the storage compartment may be used as loudspeaker enclosure for said at least one loudspeaker for reproduction of low frequencies.

The present invention relates to a carrying case respectively a briefcase with integrated loudspeaker.

The term “briefcase” or “carrying case” as used herein is intended to refer to a case with at least one exterior handle having at least one interior storage compartment intended for the protection and transport of items such as documents, papers, writing supplies, laptop computers, music players, video players, portable projectors, cell phones, calculators, portable digital assistants, electronic equipment, toys, compact discs etc.

The term “loudspeaker” as used herein is intended to refer to a single electro-acoustic transducer for reproducing audio signals from electrical signals. Audio signals are reproduced by an individual loudspeaker unit or by an assemblage of such units typically mounted in a loudspeaker enclosure and referred to as a loudspeaker system. Loudspeaker enclosures typically are designed to reinforce the low frequency audio output of the loudspeakers, said reinforcement accomplished by means of a sealed loudspeaker enclosure (so called acoustic suspension), a ported loudspeaker enclosure (so called bass-reflex), or a loudspeaker enclosure featuring an additional, non-electric loudspeaker membrane (so called passive radiator).

Today's development in the field of electronics in the entertainment and multimedia business is dominated by the trend to design electronic devices, as for example laptop computers, video cameras and video players to be smaller and lighter. For some time now in this regard sacrifices have been made with regard to the sound quality of loudspeakers integrated into such electronic devices. It appears that the available loudspeaker enclosure volume in such portable devices is insufficient to provide a natural sound reproduction especially in the low frequency range. Should it be desired to provide accurate sound reproduction in conjunction with the use of such portable devices, then a separate loudspeaker system with adequate loudspeaker enclosure volume must either be transported to or otherwise provided for at the place of usage. Due to the size and weight of such loudspeaker systems, they are seldom transported to the place of usage, so that the natural sound quality is sacrificed. On the other hand, however, the image or video quality of such electronic devices is constantly improving, with the result that presentations with such electronic devices are subject to a discrepancy between sound and image quality. Likewise in the case that a portable music player or laptop computer is used to provide music or speech reproduction the sound quality is sacrificed for the sake of portability.

The principle object of the present invention is therefore to provide a briefcase or carrying case for electronic devices as well as for documents or other such items, wherein the briefcase or carrying case may both be used as transport means as well as portable loudspeaker system. Further object of the present invention is to provide a lightweight portable loudspeaker system, which despite its lightweight provides satisfactory sound reproduction.

These objectives are accomplished in this invention by a carrying case that comprises a loudspeaker, which is mounted in either an outer or inner wall of the carrying case, for reproduction of audio frequencies, in particular low frequencies. The carrying case further comprises a storage compartment for electronic devices and documents in the interior of the briefcase, which may be used as loudspeaker enclosure for improving the low-frequency acoustic reproduction of said loudspeaker.

By use of this storage compartment as loudspeaker enclosure when the electronic devices or documents are removed from the briefcase, it may be accomplished that the briefcase providing a loudspeaker arranged in one of the outer or inner walls nearly achieves the same sound quality as standard loudspeaker systems. Due to the fact that the enclosure volume may also be used as storage compartment for the electronic devices, in particular laptop computers or video players, and presentation devices, a considerable space advantage is accomplished.

In a preferred embodiment the housing and in particular the outer walls are manufactured of a light-weight material that has a high stiffness and at the same time a high damping. Undesired interference of the sound of the speaker due to vibration of the housing, respectively the briefcase is thereby eliminated.

In a preferred embodiment, the housing of the briefcase comprises two matable shells, which are relatively stiff and at the same time are of lightweight and which are connected by means of a hinge. Preferably this hinge is separable, so that the two shells may be set up separately. In this embodiment, each shell is provided with an additional inner wall in order to provide loudspeaker enclosure volumes for each of the integrated loudspeakers. In the same manner, the enclosure volume, which according to the invention is also used as a storage compartment, may be closed by means of this inner wall or lid. It may be provided that the inner wall is arranged as a lid in the form of a pan with a deep bottom. This pan-like lid may therefore serve as a storage compartment nested into an outside shell of the carrying case. When this compartment is used as an enclosure volume for the loudspeaker, the pan-like lid may be reversed so that the deep bottom no longer extends into the outside shell but rather protrudes outwardly. Hereby it is achieved that the enclosure volume be increased to a maximum of twice its size. Also, it is provided that by means of a telescopic arrangement the enclosure volume may be increased to a multiple of its original size.

The storage compartment, and respectively the enclosure volume is lined with a padding, which on the one hand, protects the items, electronic devices or paper documents placed in the storage compartment during transportation and which, on the other hand, causes a preferred damping of the acoustic waves of the loudspeaker. The walls of the housing utilize a so-called sandwich construction, i.e. a multi-layered construction consisting of a first layer comprising a material with a maximum thickness of 4 mm and a high modulus of elasticity in shear, and of at least a second inner layer of material with a minimum thickness of 4 mm and a high shear modulus, high damping and low density, and of a third layer of material with a maximum thickness of 4 mm and a high modulus of elasticity in shear. It may however also be desired to design a sandwich structure of at least one outer layer of material with a maximum thickness of 4 mm and a high modulus of elasticity in shear and at least one inner layer of a material with a minimum thickness of 4 mm and a high shear modulus, high damping and a low density. It also may be desired to utilize one or more materials with anisotropic load-bearing characteristics in order to maximize the stiffness of the sandwich structure according to the shape and form of the carrying case shells.

The loudspeaker provided in the outer, respectively inner wall of the briefcase is preferably arranged such that its membrane, respectively its passive loudspeaker membrane is directed outwardly. According to a further preferred embodiment further means for arranging objects and electronic devices in the interior of the briefcase such as storage compartment lid with spring latches and elastic gaskets serve together as passive loudspeaker membranes respectively as passive loudspeaker membrane suspensions for a passive/radiator loudspeaker system design.

Further, the housing may comprise an acoustic damping material of at least 3 mm thickness on the insides of the interior compartments.

In a further embodiment an electrical amplifier means for increasing and controlling the loudness of the audio signal fed to the loudspeaker is provided in the briefcase. Further, a volume control potentiometer may be provided. It is also preferred to provide interface means for connections such as a loudspeaker connection, a microphone connection and so on. By means of such an interface, it is possible to attach further loudspeakers as well as other electronic devices such as laptop computers, video players and recorders or audio recording and playing devices such as MP3 players and CD players.

The briefcase may in addition to the built-in amplifier comprise an internal energy source in the form of a battery or battery pack, which may be rechargeable or which may be attached to an external power source. It is preferred that the interface providing connection facilities also provides a connection for an external power supply such as an automotive battery, airplane power supply or solar cell power supply. The connection facilities may further provide means for sending and receiving audio signals or digital signals by means of radio or infrared frequencies. It is also preferred to provide means for connecting a remote control, which receives signals either by means of radio or by means of infrared frequency.

The housing may also comprise mounting means in order to mount the speaker either to a stand or to the wall.

Further details, features and advantages of the invention will become apparent from the following description of a preferred embodiment of the briefcase according to the present invention with reference to the figures.

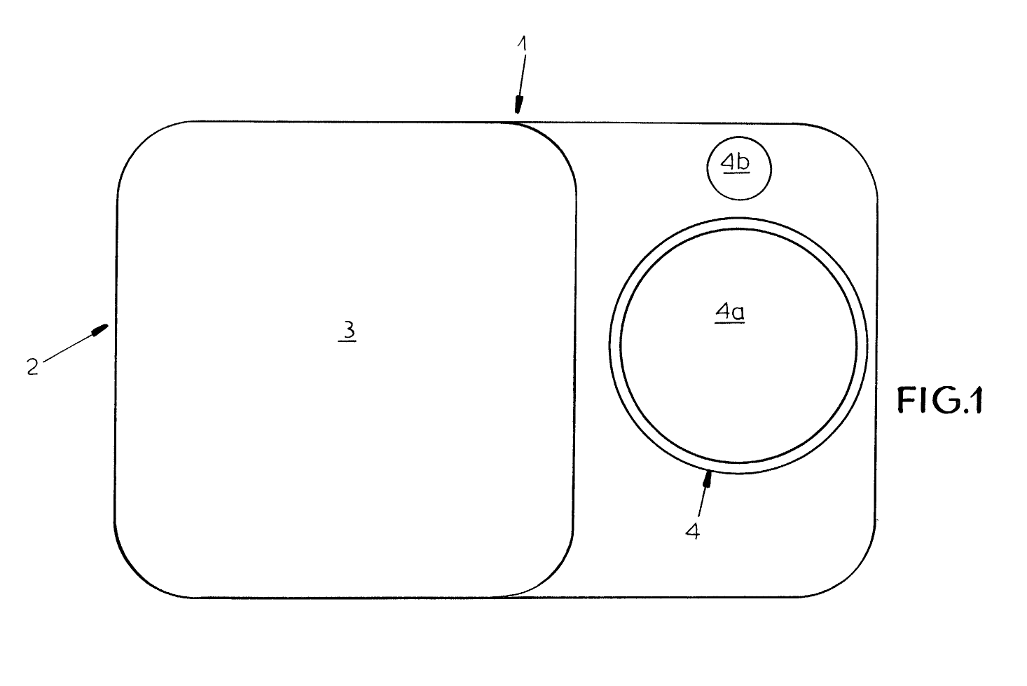

FIG. 1 a top view of the briefcase according to the invention,

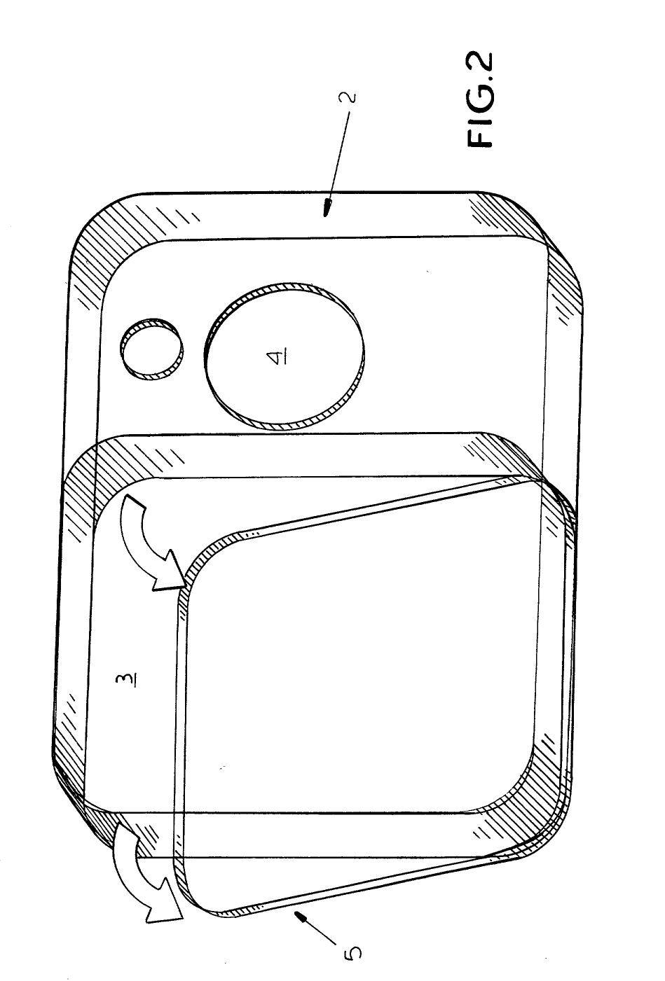

FIG. 2 a prospective side view of the briefcase according to the invention,

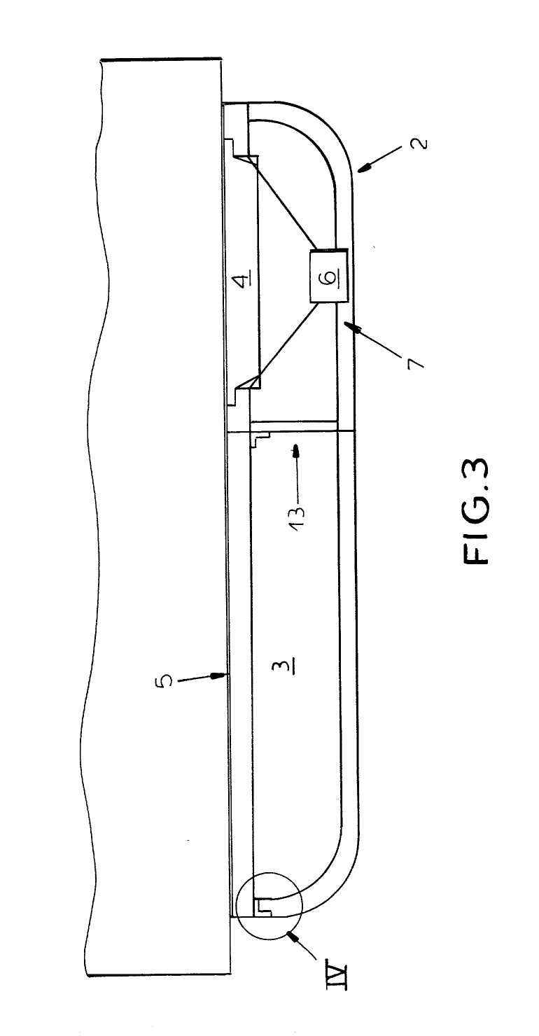

FIG. 3 a side view of the briefcase according to the invention,

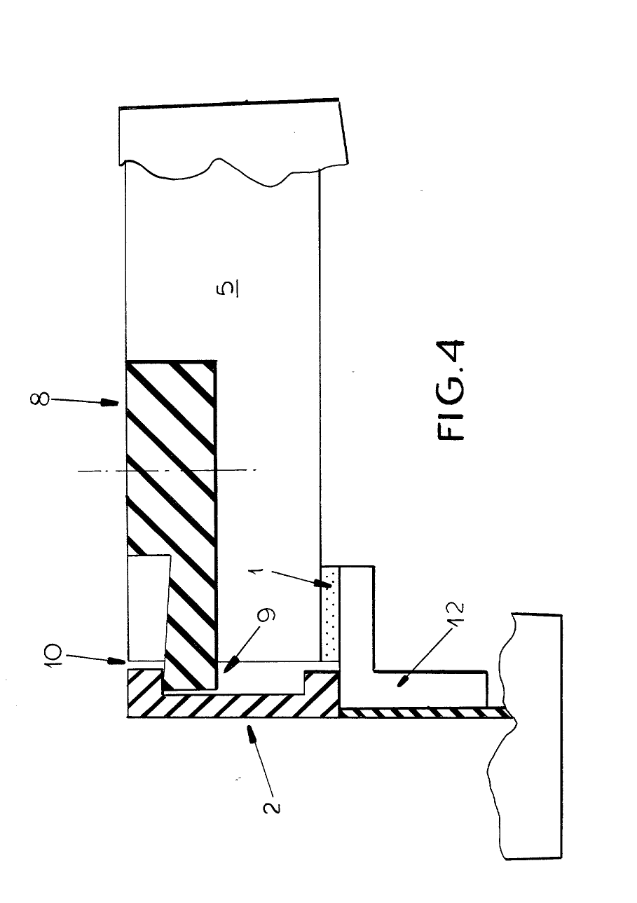

FIG. 4 a section of the side view according to FIG. 3,

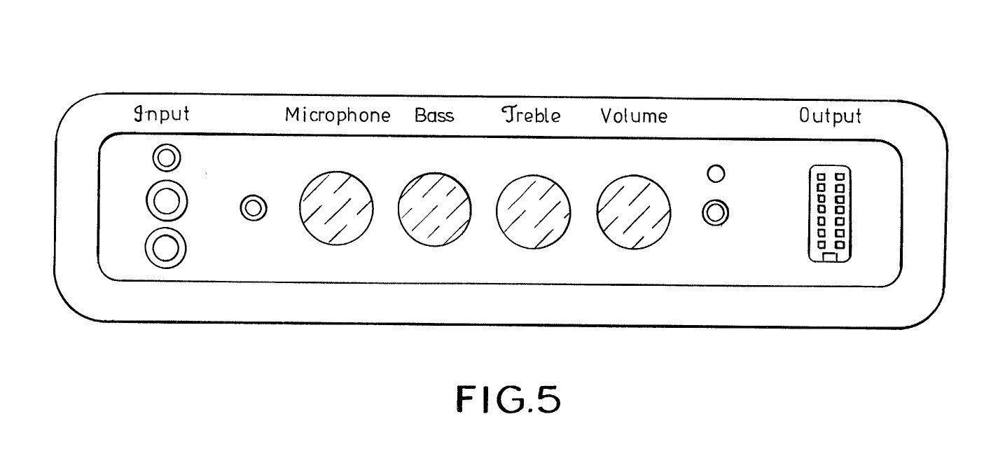

FIG. 5 a view of a preferred embodiment of the interface for connections.

In FIG. 1 a briefcase 1 is shown, which on its left side comprises a storage compartment 3 in a housing 2 and on its right side comprises a loudspeaker pair 4 consisting of a woofer 4a and a tweeter 4b. As shown in FIG. 2 the storage compartment 3 may be closed by an interior wall or lid 5.

In FIG. 3 shows a side view of the briefcase. On the right side of the housing 2, the loudspeaker 4 is arranged such that the magnet 6 of the woofer 4a is located in the lower region of the loudspeaker in the sandwich structure 7, which preferably consists of aluminium, balsa and fiberglass. The space shown in FIG. 3 on the left for storing objects is connected with the region of the housing, in which the loudspeaker 4 is arranged, by means of an opening 13 having a screen which passes air. Thereby it is ensured that the air in the resonance chamber 3 vibrates with the loudspeaker 4 and thereby contributes to a natural sound reproduction in particular in the low frequency range.

FIG. 4 shows a sectional view of the side view shown in FIG. 3, in particular the region in which the outer respectively inner wall 5 is arranged in the housing. Since this wall serves to close the resonance chamber 3, it must be ensured that a satisfactory closure is achieved. As is shown in FIG. 4, a thumbscrew fastener 8 is provided in the side of lid 5. The thumbscrew fastener 8 comprises a latch 9, which in a first position extends outwardly and interacts with a ridge 10 in the housing such that the lid 5 cannot be moved upwardly. In a second position, which is a 90° rotation from the first position, the latch 9 is positioned in the lid respectively in the wall so that the lid may be moved upwardly without any resistance.

The latch 9 is structured such that its thickness in the region in which it interacts with the ridge 10 increases during rotation from the second position into the first position and thereby presses the lid 5 downwardly against a gasket 11. The gasket 11 is arranged on an L shaped ledge 12 and causes a satisfactory closure of the resonance chamber 3.

FIG. 5 shows a view of a preferred embodiment of the interface of connections in which input and output connections as well as controllers for volume, bass, treble and a connection for a microphone are provided.

1. Briefcase respectively carrying case (1) for electronic devices or documents having a housing (2) comprising
a storage compartment (3) arranged in the housing (2) for storing at least one paper document, electronic device or object,
at least one loudspeaker (4) for reproduction of audio frequencies, which is mounted in either an outer or inner wall of the housing (2),
characterized in that, when the document or electronic device is removed, the storage compartment (3) may be used as loudspeaker enclosure for said at least one loudspeaker (4) for reproduction of low frequencies.

2. Briefcase according to claim 1, characterized in that the housing (2) and in particular the outer walls are manufactured of a material that has a high modulus of elasticity in shear and at the same time a high damping.

3. Briefcase according to claim 1, characterized in that the housing of the briefcase comprises two matable shells, which are relatively stiff and at the same time are of lightweight and which are connected by means of a hinge.

4. Briefcase according to claim 3, characterized in that the hinge is separable.

5. Briefcase according to claim 3, characterized in that each shell is provided with an additional inner wall (5).

6. Briefcase according to claim 5, characterized in that the inner wall is arranged as a lid which can be opened and closed.

7. Briefcase according to claim 6, characterized in that the inner wall is arranged as a lid in the form of a top with a deep bottom.

8. Briefcase according to claim 1, characterized in that the storage compartment, respectively the resonance chamber is lined with a padding, which on the one hand, protects the items, respectively paper documents or electronic devices placed in the storage compartment during transportation and which, on the other hand, causes a preferred damping of the acoustic waves of the loudspeaker.

9. Briefcase according to claim 1, characterized in that the walls of the housing utilize a multi-layered construction consisting of at least one outer layer of material with a maximum thickness of 4 mm and a high modulus of elasticity in shear and at least one inner layer of a material with a minimum thickness of 4 mm and a high modulus of elasticity in shear, a high damping and a low density.

10. Briefcase according to claim 1, characterized in that the walls of the housing utilize a multi-layered construction consisting of at least one first layer comprising a material with a maximum thickness of 4 mm and a high modulus of elasticity in shear, and of at least a second inner layer of material with a minimum thickness of 4 mm and a high modulus of elasiticity in shear, a high damping and low density, and of a third layer of material with a maximum thickness of 4 mm and a high modulus of elasticity in shear.

11. Briefcase according to claim 1, characterized in that the walls of the housing utilize a multi-layered construction consisting of at least one first layer comprising a material with a maximum thickness of 4 mm and a high modulus of elasticity in shear, and of at least a second inner layer of material with a minimum thickness of 4 mm and a high modulus of elasiticity in shear, a high damping and low density, and of a third layer of material with a maximum thickness of 4 mm and a high modulus of elasticity in shear, at least one of said layers utilizing one or more materials with anisotropic load-bearing characteristics.

12. Briefcase according to claim 1, characterized in that the interior of the briefcase, such as storage compartment lid with spring latches and elastic gaskets serve together as passive loudspeaker membranes respectively as passive loudspeaker membrane suspensions for a passive/radiator loudspeaker enclosure design.

13. Briefcase according to claim 1, characterized in that the housing comprises an acoustic damping material of at least 4 mm thickness on the inside of the interior compartments.

14. Briefcase according to claim 1, characterized in that the briefcase comprises an electrical amplifier means for increasing and controlling the loudness of the audio signal provided to the loudspeaker.

15. Briefcase according to claim 1, characterized in that a volume control potentiometer is provided.

16. Briefcase according to claim 1, characterized in that interface means for connections are provided.

17. Briefcase according to claim 14, characterized in that the interface means for connections comprise a loudspeaker connection or a microphone connection.

18. Briefcase according to claim 1, characterized in that it further comprises an energy source in the form of a battery, which may be rechargeable or which may be attached to an external power source, such as an automotive battery, airplane power supply or solar cell power supply.

19. Briefcase according to claim 14, characterized in that the interface means for connections comprise a connection for an external power source, such as an automotive battery, airplane power supply or solar cell power supply.

20. Briefcase according to claim 14, characterized in that the interface means for connections comprise means for sending and receiving analog and digital signals by means of radio or infrared frequency.

21. Briefcase according to claim 14, characterized in that the interface means for connections comprise means for connecting a remote control, which receives signals either by means of radio or by means of infrared frequency.

22. Briefcase according to claim 1, characterized in that the housing may also comprise mounting means in order to mount the speaker either to a stand or to the wall.
